(19) United States
(12) Patent Application Publication
(10) Pub. No.: US 2017/0061457 A1
(43) Pub. Date: Mar. 2, 2017

(54) SYSTEMS AND METHODS FOR DETERMINING SHARE OF SPEND

(71) Applicant: MasterCard International Incorporated, Purchase, NY (US)

(72) Inventors: Deepti Kalra, Hoboken, NJ (US); Henry Weinberger, New York City, NY (US); Curtis Villars, Chatham, NJ (US); Bruce MacNair, Stamford, CT (US)

(21) Appl. No.: 14/843,183

(22) Filed: Sep. 2, 2015

(51) Int. Cl. G06Q 30/02

(52) U.S. Cl. CPC G06Q 30/0204

(57) ABSTRACT

Methods and systems for determining consumer spend analytics are provided. The method includes identifying a plurality of microsegments of a population, retrieving transaction data associated with a first cardholder from a payment processing network, and matching the first cardholder to a first microsegment of the plurality of microsegments. The method also includes calculating, based at least in part on the typical income and the typical spend of the consumers in the first microsegment, a cardable spend for the first cardholder. The method further includes calculating, based at least in part on the cardable spend and the transaction data, a carded spend share that the first cardholder spent using a first payment device over the payment processing network; determining at least one consumer spend analytic based on the carded spend share; and reporting the carded spend share and the at least one consumer spend analytic.

### BACKGROUND

The field of the disclosure relates generally to processing data, and more particularly, to the determination of consumer spend analytics.

In today's business world, many decisions are made based on information products including collections of data that are analyzed and represented in useful ways for the variety of businesses that rely on them. For example, these information products may reveal consumer trends, financial trends, and regional and demographic information. The more accurate and truly representational of a sample population about which they are produced, the more useful information products may be, and the more businesses may want to purchase and utilize them.

For example, payment processing companies may want to determine how consumers or cardholders are using their services to initiate transactions, for example, to purchase goods and services from merchants. However, it is difficult to gain insight into consumer behaviors, because in at least some cases, payment processing companies only have access to data associated with transactions made using their branded payment cards processed over their networks. Purchases made using payment cards associated with different payment processing companies or paid using cash or check may be “invisible” to one or more particular payment processing companies.

### BRIEF DESCRIPTION OF THE DISCLOSURE

In one aspect, a computer-implemented method for determining consumer spend analytics using a spend analysis computer device is provided. The spend analysis computing device includes a processor and a memory. The method includes identifying a plurality of microsegments of a population. Each microsegment includes a set of consumers having a typical income and a typical spend within a predetermined range associated with the microsegment. The typical income and the typical spend are determined based at least in part on consumer expenditure data. The method also includes retrieving transaction data associated with a first cardholder from a payment processing network; matching the first cardholder to a first microsegment of the plurality of microsegments; and calculating, based at least in part on the typical income and the typical spend of the set of consumers in the first microsegment, a cardable spend for the first cardholder. The method further includes calculating, based at least in part on the cardable spend and the retrieved transaction data, a carded spend share that the first cardholder spent using a first payment device over the payment processing network; determining at least one consumer spend analytic based on the carded spend share; and reporting the carded spend share for the first cardholder and the at least one consumer spend analytic.

In another aspect, a spend analysis computing device used to determine consumer spend analytics is provided. The spend analysis computing device includes a processor communicatively coupled to a memory device. The processor is programmed to identify a plurality of microsegments of a population. Each microsegment includes a set of consumers having a typical income and a typical spend within a predetermined range associated with the microsegment, and the typical income and the typical spend are determined based at least in part on consumer expenditure data. The processor is further programmed to retrieve, from a payment processing network, transaction data associated with a first cardholder, and match the first cardholder to a first microsegment of the plurality of microsegments. The processor is also programmed to calculate, based at least in part on the typical income and the typical spend of the set of consumers in the first microsegment, a cardable spend for the first cardholder; calculate, based at least in part on the cardable spend and the retrieved transaction data, a carded spend share that the first cardholder spent using a first payment device over the payment processing network; and determine at least one consumer spend analytic based on the carded spend share. The processor is further programmed to report the carded spend share for the first cardholder and the at least one consumer spend analytic.

In yet another aspect, at least one non-transitory computer-readable storage media having computer-executable instructions embodied thereon is provided. When executed by a spend analysis computing device having at least one processor coupled to at least one memory device, the computer-executable instructions cause the processor to identify a plurality of microsegments of a population. Each microsegment includes a set of consumers having a typical income and a typical spend within a predetermined range associated with the microsegment, and the typical income and the typical spend are determined based at least in part on consumer expenditure data. The computer-executable instructions further cause the processor to retrieve, from a payment processing network, transaction data associated with a first cardholder; match the first cardholder to a first microsegment of the plurality of microsegments; and calculate, based at least in part on the typical income and the typical spend of the set of consumers in the first microsegment, a cardable spend for the first cardholder. The computer-executable instructions also cause the processor to calculate, based at least in part on the cardable spend and the retrieved transaction data, a carded spend share that the first cardholder spent using a first payment device over the payment processing network; determine at least one consumer spend analytic based on the carded spend share; and report the carded spend share for the first cardholder and the at least one consumer spend analytic.

### BRIEF DESCRIPTION OF THE DRAWINGS

FIGS. 1-8 show example embodiments of the methods and systems described herein.

FIG. 1 is a schematic diagram illustrating an example multi-party payment card industry system for enabling payment-by-card transactions in accordance with one embodiment of the present disclosure.

FIG. 2 is a simplified block diagram of an example computer system used for determining consumer spend analytics in accordance with one embodiment of the present disclosure.

FIG. 3 illustrates an example configuration of a client device shown in FIG. 2.

FIG. 4 illustrates an example configuration of a server system shown in FIG. 2.

FIG. 5 shows an example table of microsegments identified by a spend analysis computing device as shown in FIG. 2.

FIG. 6 shows a data-flow diagram illustrating the determination of consumer spend analytics by the spend analysis computing device as shown in FIG. 2.

FIG. 7 is a flowchart of a process for determining consumer spend analytics using the system shown in FIG. 2.

FIG. 8 is a diagram of components of a computer device that may be used in the system shown in FIG. 2.

Like numbers in the figures indicate the same or functionally similar components. Although specific features of various embodiments may be shown in some figures and not in others, this is for convenience only. Any feature of any figure may be referenced and/or claimed in combination with any feature of any other figure.

### DETAILED DESCRIPTION OF THE DISCLOSURE

The systems and methods described herein are directed to determining consumer spend analytics. The system includes a payment processing network, a spend analysis computing device, and at least one third party. The at least one third party may include at least one of a credit-reporting agency, a geodemographic reporting party, and a government agency. In some embodiments, the spend analysis computing device is integral to or is otherwise in communication with the payment processing network. In some embodiments, the spend analysis computing device is integral to or is otherwise in communication with at least one of a merchant, an issuer, and an acquirer. The spend analysis computing device may further be in communication with at least one of the credit-reporting agency, the geodemographic reporting agency, and the government agency.

Consumers may use payment devices (e.g., credit cards, debit cards, or other devices that manage payment account information) to pay for goods and/or services at merchant locations. Cardholders (e.g., a consumer using a payment device such as a credit card, debit card, or other device that manages payment account information) will initiate payment transactions with merchants at these merchant locations. Transaction data associated with these payment transactions (“transactions”) are received and processed by a payment processor over a payment processing network. The transaction data include, among other data points, data associated with the cardholder and the merchant involved in the payment transaction. For example, transaction data may include one or more of: a merchant identifier that can be used by the payment processor to identify or look up the location of the merchant, a transaction amount, a time and date of the transaction, data descriptive of the purchase, a location of the transaction, a cardholder identifier, and cardholder account data.

As used herein, the term “cardholder” refers generally to consumers having and/or using a payment device associated with one payment processing network and/or payment processing company (e.g., MasterCard®, VISA®, American Express®, and First Data Corp.®). “Non-cardholder” refers generally to consumers not having or using a payment device associated with the payment processing network. “Non-cardholders” may have and/or use payment device(s) associated with other payment processing networks, or may use cash, checks, or other methods of payment not associated with the payment processing network. “Consumers” refers generally to both cardholders and non-cardholders collectively.

As used herein, the terms “transaction card,” “financial transaction card,” “payment card,” and “payment device” refer to any suitable transaction card, such as a credit card, a debit card, a charge card, a membership card, a promotional card, a frequent flyer card, an identification card, a prepaid card, a gift card, and/or any other device that may hold payment account information, such as mobile phones, smartphones, personal digital assistants (PDAs), key fobs, and/or computers. Each type of payment device can be used as a method of payment for performing a transaction.

In the example embodiment, the spend analysis computing device is configured to retrieve transaction data from the payment processing network, wherein the transaction data includes data associated with transactions initiated by cardholders using a payment device over the payment processing network. The spend analysis computing device may be further configured to receive geodemographic data from the geodemographic reporting party. As used herein, “geodemographic data” may include, for example, geographic data associated with a geographic area and demographic data associated with consumers located in the geographic area. Demographic data may include, for example, age variables, income variables, household composition, and other socioeconomic variables descriptive of consumers in the geographic area. A geodemographic reporting party may be any party that collects, receives, stores, analyzes, or otherwise processes geodemographic data. The geodemographic reporting party may be associated with or otherwise in communication with the payment processing network.

The spend analysis computing device may be configured to identify a plurality of microsegments of a population of a geographic area. As used herein, “microsegment” refers generally to a division of the population, wherein like members of the population (e.g., consumers and/or cardholders) are grouped together and associated with the microsegment based on the geodemographic data. For example, consumers with like incomes, ages, and/or other geodemographic characteristics may be grouped together into the same microsegment. In one particular example, a microsegment includes consumers having a personal or household income and/or a personal or household expenditure within a predetermined range associated with the microsegment. The spend analysis computing device may use geodemographic data, consumer expenditure data (described below), credit-reporting data, or any other data to identify the plurality of microsegments.

In the example embodiment, the spend analysis computing device is further configured to receive consumer expenditure data from a third party, such as a government agency or any other agency having aggregate consumer expenditure data. In one embodiment, consumer expenditure data may include Government Consumer Expenditure Survey (GCES) data. As used herein, “GCES data” may include some or all of the data from the GCES and/or the GCES itself, in any suitable format for use in the methods and systems described herein. In other embodiments, consumer expenditure data may include aggregate data regarding consumer income and spending from any other source. Consumer expenditure data may also include census data. Generally, consumer expenditure data provides information regarding consumer spend behavior, including expenditures and income, for consumers having certain geodemographic characteristics. The spend analysis computing device uses the consumer expenditure data to determine a typical income and a typical spend for a consumer in each identified microsegment. A “typical income” refers generally to an average income of a consumer in a microsegment, or another calculated amount earned that is assigned to the consumer in the microsegment. A “typical spend” refers generally to an average expenditure (i.e., a total amount spent) by the consumer in the microsegment within a given period of time (e.g., a month, a season, a year, etc.), or another calculated amount assigned to the consumer that represents a spend amount for a consumer in that microsegment.

In some embodiments, the spend analysis computing device may be further configured to receive credit-reporting data from the credit-reporting agency. As used herein, “credit-reporting data” refers generally to data received from a credit-reporting agency, such as Experian®. Credit-reporting data may include, for example, consumer identification data (e.g., name, address, social security number), credit account data (e.g., loan or lease information), public records (e.g., bankruptcy records, tax liens), and collection account data (e.g., information reported by collection agencies). In some embodiments, the spend analysis computing device may use credit-reporting data and/or transaction data to match a cardholder to an identified microsegment. In other embodiments, the spend analysis computing device may use other matching logic to match each cardholder to an identified microsegment. The matching logic may use transaction data, geodemographic data, various algorithms, and any other relevant data to match the cardholder to the microsegment.

In the example embodiment, the spend analysis computing device is configured to calculate a “cardable spend” for each cardholder. As used herein, “cardable spend” refers generally to expenditures (e.g., purchases of goods and services, making payments, and other spending) that can be made using a payment device (e.g., a credit card or another type of payment card). As will be described in further detail below, a cardholder's cardable spend is determined by subtracting from a cardholder's income all transactions that are generally not made using a credit card, referred to herein as “noncardable expenditures.” For example, transactions involving mortgages, healthcare, taxes, savings, and certain other expenditures may be considered noncardable expenditures, because these transactions may not be completed using a credit card. Mortgages and taxes, in at least some cases, cannot be paid using a credit card; and healthcare transactions often involve third parties such as insurance companies in the payment process for such transactions. Generally, the spend analysis computing device uses the typical income and the typical spend for the microsegment that the cardholder is in (i.e., matched to) to calculate each cardholder's cardable spend.

The spend analysis computing device is further configured to use a cardholder's cardable spend and the retrieved transaction data to make more accurate determinations about the share of a cardholder's cardable spend (“carded spend share”) that is spent during transactions initiated using a payment device over a particular payment processing network. In other words, the spend analysis computing device may more accurately determine the carded spend share for, for example: a MasterCard® credit card based on transaction data received from the MasterCard® payment processing network; a VISA® credit card based on transaction data received from the VISA® payment processing network; or a American Express® credit card based on transaction data received from the American Express® payment processing network. The spend analysis computing device may be further configured to use the carded spend share and various other sets of data to determine various consumer spend analytics, as will be described in more detail below.

The consumer spend analytics, which may be reported to the payment processing network and to any other interested parties, may be useful in describing or revealing various consumer spending trends. In at least some cases, the calculated carded spend share can be used to determine cardholder spending behaviors using payment methods “invisible” to the payment processing network. The determination of cardholder spending in various merchant industries (e.g., food, gas, clothing, etc.) using different payment methods may be more accurate than determinations of a cardable spend share made using other known methods.

For example, in at least some known methods, payment processing companies (and other parties interested in consumer spend behaviors) purchase regional credit card information from credit-reporting agencies such as Experian®. This information provides the number of American Express®, VISA®, and MasterCard® credit cards issued in a particular zip code or set of zip codes. From this information, the relative share or ratio of the credit-card based transactions in that particular zip code or area related to the set of zip codes are inferred. The credit-reporting information is leveraged with institution-particular knowledge of cardholder activity at a merchant location or in a merchant industry. For example, payment processing company A knows that ten transactions were made by cardholders using a credit card over payment processing company A's network at a particular merchant location, with these ten transactions totaling revenue of $1,000. From the credit-reporting information, payment processing company A also knows that 25% of the credit cards in the region (a particular set of zip codes) are credit cards associated with payment processing company A, with the balance being credit cards associated with payment processing company B and/or associated with payment processing company C, for example. Payment processing company A may then infer that the ten transactions at the merchant location are only 25% of the total credit-card transactions at that merchant location. Thus, payment processing company A may estimate that 40 credit-card transactions were performed at the merchant location. Payment processing company A may further infer that the $1,000 of revenue it recorded for the merchant location is only 25% of the total credit-card revenue at the merchant location. Thus, payment processing company A may estimate that the total credit-card revenue for the merchant location was $4,000. However, the data for cash, debit, and check purchases are missing in these determinations.

The systems and methods herein are directed to improving determinations of carded spend shares by leveraging at least one of geodemographic data, consumer expenditure data, transaction data, and credit-reporting data to better determine carded spend shares. By dividing a population into microsegments based on, for example, shared geodemographic and/or socioeconomic characteristics, behavior of cardholders in each microsegment is more accurately determined, and, accordingly, the carded spend share calculations may be improved over previous methods. Further, the consumer spend analytics described below expand on carded spend share calculations for individual cardholders by inferring and determining microsegment- and industry-wide cardholder and consumer behaviors.

The parties that receive the consumer spend analytics may use these analytics in order to develop and/or implement various strategies to encourage and/or change certain consumer spending trends. For example, an issuer bank may issue a payment device to a plurality of consumers, wherein each payment device is associated with a payment processing network (and thus the consumers are now referred to, in this example, as cardholders). The spend analysis computing device may be configured to report the calculated carded spend share for each cardholder and the determined consumer spend analytics to the issuer bank. The issuer bank may implement a first strategy that targets those cardholders with low carded spend shares associated with the payment device, in order to encourage those cardholders to use the payment device more frequently. The issuer bank may implement a second strategy that targets cardholders with average carded spend shares, in order to encourage those cardholders to make the payment device their primary payment device. The issuer bank may implement a third strategy that targets cardholders in a specific microsegment or microsegments, in order to encourage those cardholders to use the payment device more frequently in a particular merchant industry or industries.

The methods and systems described herein may be implemented using computer programming or engineering techniques including computer software, firmware, hardware, or any combination or subset therefor. At least one of the technical problems addressed by this system includes: (i) inaccurate determinations of carded spend share spent by cardholders using payment cards associated with a payment processing network; and (ii) inaccurate determinations of consumer spend statistics and trends in various merchant industries.

The technical effect of the systems and methods described herein is achieved by performing at least one of the following steps: (i) identifying a plurality of microsegments of a population, wherein each microsegment includes a set of consumers having a typical income and a typical spend within a predetermined range associated with the microsegment, and wherein the typical income and the typical spend are determined based at least in part on consumer expenditure data; (ii) retrieving transaction data associated with a first cardholder from a payment processing network; (iii) matching the first cardholder to a first microsegment of the plurality of microsegments; (iv) calculating, based at least in part on the typical income and the typical spend of the set of consumers in the first microsegment, a cardable spend for the first cardholder; (v) calculating, based at least in part on the cardable spend and the retrieved transaction data, a carded spend share that the first cardholder spent using a first payment device over the payment processing network; (vi) determining at least one consumer spend analytic based on the carded spend share; and (vii) reporting the carded spend share for the first cardholder and the at least one consumer spend analytic.

The resulting technical effect achieved is at least one of: (i) more accurate determinations of carded spend share of cardholders associated with a payment processing network; and (ii) more accurate determinations of consumer spend in various merchant industries.

The following detailed description illustrates embodiments of the disclosure by way of example and not by way of limitation. It is contemplated that the embodiments have general application to processing financial transaction data and geodemographic data by a third party in industrial, commercial, and residential applications.

Described herein are computer systems such as a spend analysis computing device and related computer systems. As described herein, all such computer systems include a processor and a memory. However, any processor in a computing device referred to herein may also refer to one or more processors, wherein the processor may be in one computing device or a plurality of computing devices acting in parallel. Additionally, any memory in a computing device referred to herein may also refer to one or more memories, wherein the memories may be in one computing device or a plurality of computing devices acting in parallel.

As used herein, a processor may include any programmable system including systems using microcontrollers, reduced-instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term “database.” Examples of RDBMS's include, but are not limited to including, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer-readable medium. In an example embodiment, the system is executed on a single computer system, without requiring a connection to a server computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium.

As used herein, an element or step recited in the singular and proceeded with the word “a” or “an” should be understood as not excluding plural elements or steps, unless such exclusion is explicitly recited. Furthermore, references to “one embodiment” of the present disclosure are not intended to be interpreted as excluding the existence of additional embodiments that also incorporate the recited features.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only and are thus not limiting as to the types of memory usable for storage of a computer program.

The systems and processes are not limited to the specific embodiments described herein. In addition, components of each system and each process can be practiced independently and separate from other components and processes described herein. Each component and process also can be used in combination with other assembly packages and processes.

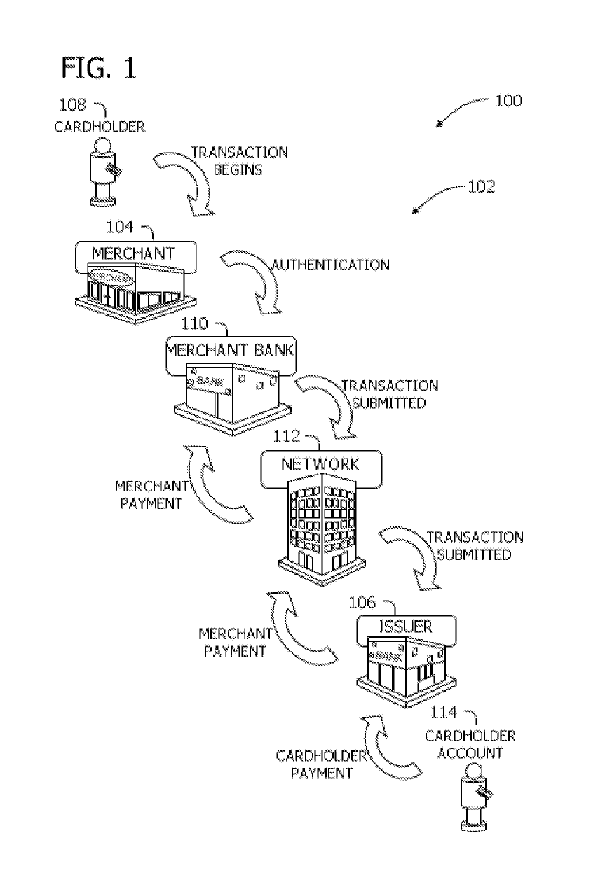

FIG. 1 is a schematic diagram 100 illustrating an example multi-party payment card industry system 102 for enabling payment-by-card transactions, which may be used for determining consumer spend analytics. The methods and systems described herein relate to a payment card system, such as a credit card payment system using the MasterCard® interchange. The MasterCard® interchange is a proprietary communications standard promulgated by MasterCard International Incorporated® for the exchange of financial transaction data between financial institutions that are customers of MasterCard International Incorporated® (MasterCard is a registered trademark of MasterCard International Incorporated located in Purchase, N.Y.).

In a typical payment card system, a financial institution called the “issuer” 106 issues a payment card or electronic payments account identifier, such as a credit card, to a consumer or cardholder 108, who uses the payment card to tender payment for a purchase from a merchant 104. To accept payment with the payment card, merchant 104 must normally establish an account with a financial institution that is part of the financial payment system. This financial institution is usually called the “merchant bank” 110 or the “acquiring bank” or “acquirer bank.” When cardholder 108 tenders payment for a purchase with the payment card, merchant 104 requests authorization from merchant bank 110 for the amount of the purchase. The request may be performed over telephone, but is usually performed through the use of a point-of-sale (POS) terminal (not shown in FIG. 1), which reads the payment card identification information from, for example, a magnetic stripe, a chip, or embossed characters on the payment card and communicates electronically with the transaction processing computers of merchant bank 110. Alternatively, merchant bank 110 may authorize a third party (not shown in FIG. 1) to perform transaction processing on its behalf. In this case, a POS terminal of the merchant 104 will be configured to communicate with the third party. Such a third party is usually called a “merchant processor” or an “acquiring processor.”

Using an interchange network 112 (also known as a “payment network” or “payment processing network”), the computers of merchant bank 110 or the merchant processor will communicate with the computers of issuer bank 106 to determine whether the cardholder's account is in good standing and whether the purchase is covered by the cardholder's available credit line. Based on these determinations, the request for authorization will be declined or approved. If the request for authorization is approved, an authorization code is issued to merchant 54 via an authorization response message.

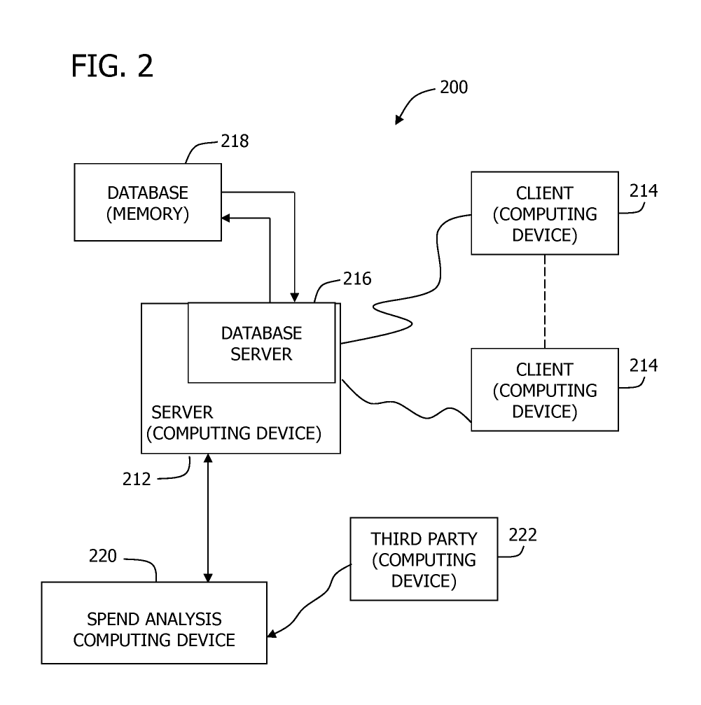

When a request for authorization is approved, the available credit line of cardholder's account 114 is decreased. Normally, a charge is not posted immediately to the cardholder's account because bankcard associations have promulgated rules that do not allow merchant 104 to charge, or “capture,” a transaction until goods are shipped or services are delivered. However, with respect to at least some debit-card transactions, a charge may be posted at the time of the transaction. When merchant 104 ships or delivers the goods or services, merchant 104 captures the transaction by, for example, appropriate data-entry procedures on the POS terminal. If cardholder 108 cancels a transaction before it is captured, a “void” is generated. If cardholder 108 returns goods after the transaction has been captured, a “credit” is generated. Interchange network 112 and/or issuer bank 106 stores the transaction card information, such as a category of merchant/merchant industry, a merchant identifier, a location where the transaction was completed, a purchase amount, and a date and time of the transaction, in a database 218 (shown in FIG. 2).

After a purchase has been made, a clearing process occurs to transfer additional transaction data related to the purchase among the parties to the transaction, such as merchant bank 110, interchange network 112, and issuer bank 106. More specifically, during and/or after the clearing process, additional data, such as a time of purchase, a merchant name, a type of merchant, purchase information, cardholder account information, a type of transaction, information regarding the purchased item and/or service, and/or other suitable information, is associated with a transaction and transmitted between parties to the transaction as transaction data, and may be stored by any of the parties to the transaction.

For debit card transactions, when a request for a personal identification number (PIN) authorization is approved by the issuer, cardholder's account 114 is decreased. Normally, a charge is posted immediately to cardholder's account 114. The payment card association then transmits the approval to the acquiring processor for distribution of goods/services or information, or cash in the case of an automated teller machine (ATM).

After a transaction is authorized and cleared, the transaction is settled among merchant 104, merchant bank 110, and issuer bank 106. Settlement refers to the transfer of financial data or funds among merchant's 104 account, merchant bank 110, and issuer bank 106 related to the transaction. Usually, transactions are captured and accumulated into a “batch,” which is settled as a group. More specifically, a transaction is typically settled between issuer bank 106 and interchange network 112, and then between interchange network 112 and merchant bank 110, and then between merchant bank 110 and merchant 104.

Interchange network 112 may further be in communication with a spend analysis computing device 220 (shown in FIG. 2). Interchange network 112 may communicate transaction data captured over payment system 102 to spend analysis computing device 220 for analysis, as will be described in more detail below.

FIG. 2 is a simplified block diagram of an example system 200 that may be used for determining consumer spend analytics in accordance with one embodiment of the present disclosure. In the example embodiment, system 200 is a payment processing system that includes a spend analysis computing device 220 configured to determine consumer spend analytics. Spend analysis computing device 220 is configured to retrieve transaction data from a payment processing network (such as payment processing network 112, shown in FIG. 1) and to receive consumer expenditure data from a third party computing device 222 (such as, for example, a computing device associated with a government agency or any other third party). Using retrieved and/or received data, spend analysis computing device 220 is configured to calculate a cardable spend and a carded spend share associated with payment processing network 112 for a cardholder (such as cardholder 108, shown in FIG. 1) and to determine consumer spend analytics. Spend analysis computing device 220 is further configured to report the carded spend share (the share of cardable spend of cardholder 108 spent using a payment device associated with payment processing network 112) for cardholder 108 and the consumer spend analytics (such as, for example, an average carded spend share for a plurality of cardholders) to payment processing network 112.

In the example embodiment, system 200 includes a plurality of computer devices. More specifically, in the example embodiment, system 200 includes spend analysis computing device 220, which is communicatively coupled to a server system 212. Spend analysis computing device 220 can access server system 212 to store and access data, such as transaction data, consumer expenditure data, geodemographic data, credit-reporting data, and any other relevant data. In the example embodiment, spend analysis computing device 220 is further in communication with third party computing device 222 and may receive consumer expenditure data from third party computing device 222. Spend analysis computing device may access server system 212 to store received consumer expenditure data.

In some embodiments, spend analysis computing device 220 may be associated with, or is part of, payment processing network 112, or in may be communication with payment processing network 112. In other embodiments, spend analysis computing device 220 is associated with a third party and is merely in communication with payment processing network 112. In some embodiments, spend analysis computing device 220 may be associated with, be in communication with, or be part of, at least one of payment processing system 102, merchant bank 106, and issuer bank 110 (all shown in FIG. 1).

In the example embodiment, client systems 214 (also known as client computing devices) are computers that include a web browser or a software application, which enables client systems 214 to access server system 212 using the Internet. More specifically, client systems 214 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Client systems 214 can be any device capable of accessing the Internet including, but not limited to, a desktop computer, a laptop computer, a personal digital assistant (PDA), a cellular phone, a smartphone, a tablet, a phablet, or other web-based connectable equipment.

A database server 216 is communicatively coupled to a database 218 that stores data. In one embodiment, database 218 includes at least one of transaction data, consumer expenditure data, geodemographic data, and credit-reporting data. In the example embodiment, database 218 is stored remotely from server system 212. In some embodiments, database 218 is decentralized.

In some embodiments, server system 212 may be associated with payment processing network 112 and may be referred to as a payment processor computer system. Server system 212 may be used for processing transaction data. In addition, at least one of client systems 214 may include a computer system associated with an issuer of a payment device. Accordingly, server system 212 and client systems 214 may be utilized to process transaction data relating to purchases cardholder 108 makes utilizing a payment device processed by payment processing network 112 and issued by associated issuer 106. At least one client system 214 may be associated with a user or a cardholder seeking to register, access information, or process a transaction with at least one of payment processing network 112, issuer 106, or merchant 104. In addition, client systems 214 may include point-of-sale (POS) devices associated with a merchant and used for processing payment transactions. In the example embodiment, client systems 214 may be associated with merchant bank 110 and transmit transactions originating from merchant 104, while server system 212 may be payment processing network 112.

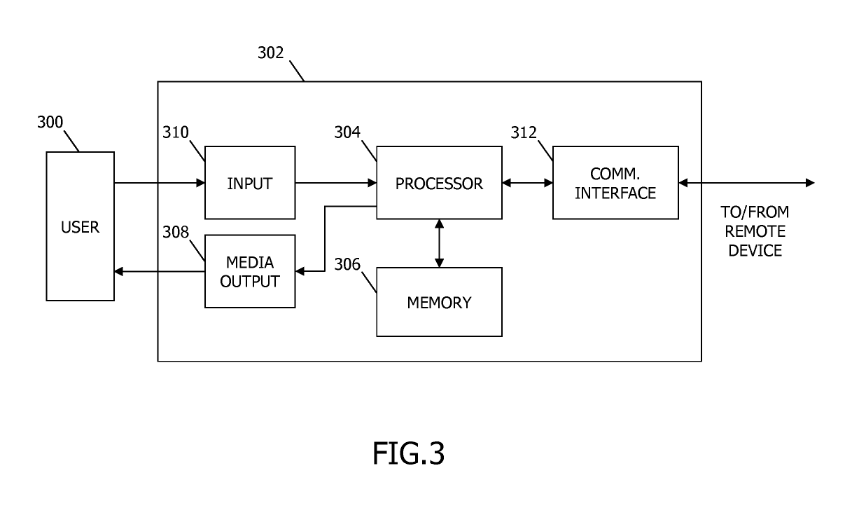

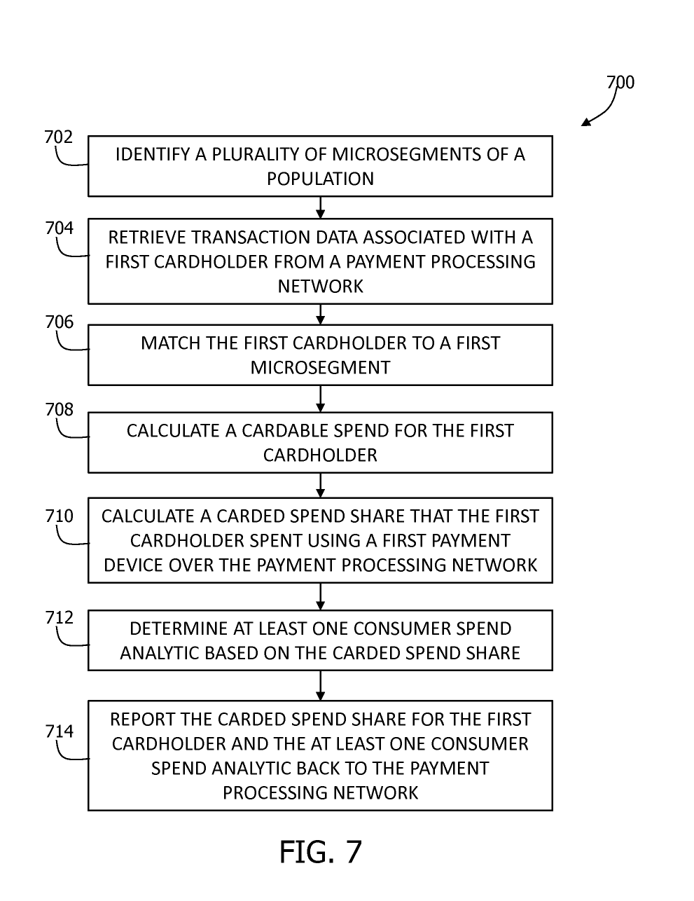

FIG. 3 illustrates an example configuration of a client device 214 (shown in FIG. 2) in accordance with one embodiment of the present disclosure. User computer device 302 is operated by a user 300. User computer device 302 may include, but is not limited to, client systems 214, spend analysis computing device 220, and third party computing device 222. User computer device 302 includes a processor 304 for executing instructions. In some embodiments, executable instructions are stored in a memory area 306. Processor 304 may include one or more processing units (e.g., in a multi-core configuration). Memory area 306 is any device allowing information such as executable instructions and/or transaction data to be stored and retrieved. Memory area 306 may include one or more computer-readable media. Processor 304 executes computer-executable instructions for implementing aspects of the disclosure. In some embodiments, processor 304 is transformed into a special-purpose microprocessor by executing computer-executable instructions or by otherwise being programmed. For example, processor 304 is programmed with instructions such as are illustrated in FIG. 7.

User computer device 302 also includes at least one media output component 308 for presenting information to user 300. Media output component 308 is any component capable of conveying information to user 300. In some embodiments, media output component 308 includes an output adapter (not shown) such as a video adapter and/or an audio adapter. The output adapter is operatively coupled to processor 304 and operatively couplable to an output device such as a display device (e.g., a liquid crystal display (LCD), organic light emitting diode (OLED) display, or “electronic ink” display) or an audio output device (e.g., a speaker or headphones). In some embodiments, media output component 308 is configured to present a graphical user interface (e.g., a web browser and/or a client application) to user 300. A graphical user interface may include, for example, an online store interface for viewing and/or purchasing items, and/or a wallet application for managing payment information.

In some embodiments, user computer device 302 includes an input device 310 for receiving input from user 300. User 300 may use input device 310 to, without limitation, select and/or enter one or more items to purchase and/or a purchase request, or to access credential information and/or payment information. Input device 310 may include, for example, a keyboard, a pointing device, a mouse, a stylus, a touch-sensitive panel (e.g., a touch pad or a touch screen), a gyroscope, an accelerometer, a position detector, and/or an audio input device. A single component such as a touch screen may function as both an output device of media output component 308 and input device 310.

User computer device 300 may also include a communication interface 312, which is communicatively couplable to a remote device such as server system 212 (shown in FIG. 2). Communication interface 312 may include, for example, a wired or wireless network adapter or a wireless data transceiver for use with a mobile phone network (e.g., Global System for Mobile communications (GSM), 3G) or other mobile data network (e.g., Worldwide Interoperability for Microwave Access (WIMAX)).

Stored in memory area 306 are, for example, computer-readable instructions for providing a user interface to user 300 via media output component 308 and, optionally, receiving and processing input from input device 310. A user interface may include, among other possibilities, a web browser and/or a client application. Web browsers enable users, such as user 300, to display and interact with media and other information typically embedded on a web page or a website from server system 212. A client application allows user 300 to interact with, for example, server system 212. For example, instructions may be stored by a cloud service, and the output of the execution of the instructions sent to media output component 308.

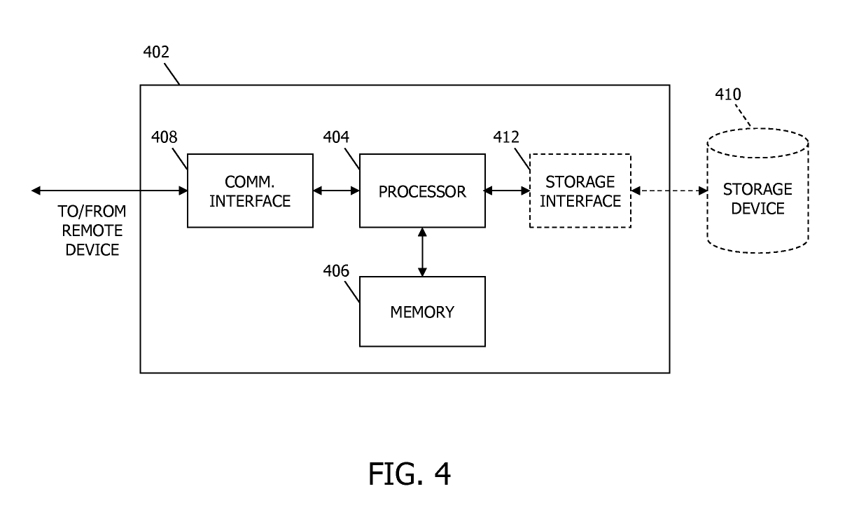

FIG. 4 illustrates an example configuration of a server system 212 (shown in FIG. 2), in accordance with one embodiment of the present disclosure. Server computer device 402 may include, but is not limited to, server system 212, spend analysis computer device 220, database server 216, and third party computing device 222 (all shown in FIG. 2). Server computer device 402 includes a processor 404 for executing instructions. Instructions may be stored in a memory area 406. Processor 404 may include one or more processing units (e.g., in a multi-core configuration).

Processor 404 is operatively coupled to a communication interface 408 such that server computing device 402 is capable of communicating with a remote device such as another server computer device 402, client systems 214 (shown in FIG. 2), or spend analysis computing device 220. For example, communication interface 408 may receive requests from client systems 214.

Processor 404 may also be operatively coupled to a storage device 410. Storage device 410 is any computer-operated hardware suitable for storing and/or retrieving data, such as, but not limited to, data associated with database 218 (shown in FIG. 2). In some embodiments, storage device 410 is integrated in server computing device 402. For example, server computing device 402 may include one or more hard disk drives as storage device 410. In other embodiments, storage device 410 is external to server computing device 402 and may be accessed by a plurality of server computing devices 402. For example, storage device 410 may include a storage area network (SAN), a network-attached storage (NAS) system, and/or multiple storage units such as hard disks and/or solid-state disks in a redundant array of inexpensive disks (RAID) configuration.

In some embodiments, processor 404 is operatively coupled to storage device 410 via a storage interface 412. Storage interface 412 is any component capable of providing processor 404 with access to storage device 410. Storage interface 412 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 404 with access to storage device 410.

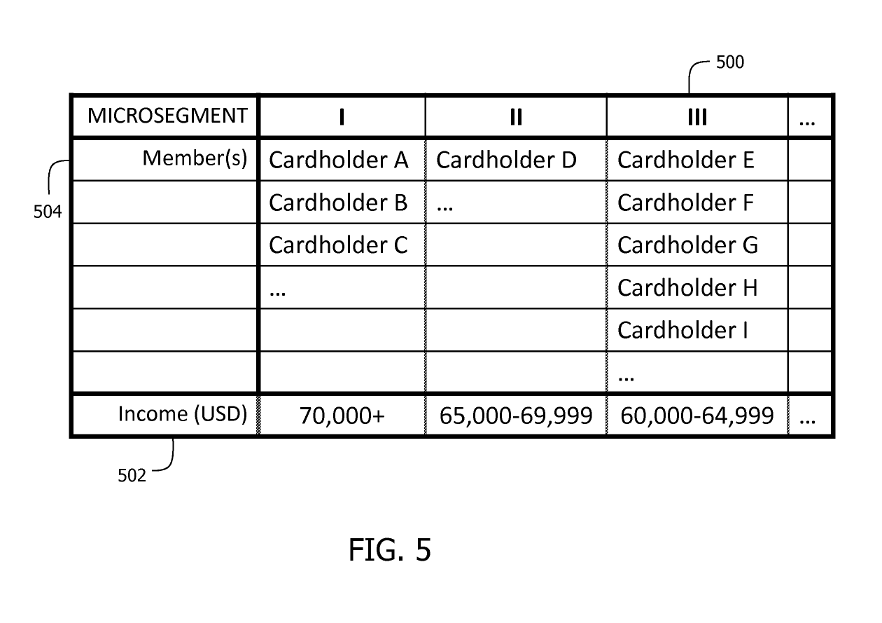

FIG. 5 shows an example table 500 of microsegments identified by spend analysis computing device 220 (shown in FIG. 2) in accordance with one embodiment of the present disclosure. Microsegments may represent a set of consumers in a population that each have a particular typical income and a particular typical spend within a predetermined range. In other words, microsegments are identified to group like consumers. Spend analysis computing device 220 may be configured to identify microsegments I, II, and III based at least in part on at least one of geodemographic data (received from a geodemographic reporting party), consumer expenditure data (received from a third party), and/or received credit-reporting data (received from a credit-reporting agency). Although only three microsegments (I, II, and III) are shown herein for example purposes, spend analysis computing device 220 is configured to identify any number of microsegments. Microsegments I, II, and III may be identified and/or defined based on geodemographic and/or socioeconomic characteristics. In the example embodiment, microsegments I, II, III are identified based on income range 502 of consumers included in each microsegment. In the example embodiment, income range 502 is shown as increments of $5,000; however, in other embodiments, income range 502 may be increments of any other amount (e.g., increments of $10,000, $25,000, $1,000, or any other amount), and income range 502 need not be divided by equal increments. For example, in another embodiment, microsegments I, II, III may be identified based on an income range 502 of $100,000+, $90,000-99,999, $85,000-89,999, $84,000-84,999, etc. In other embodiments, microsegments I, II, III may be, alternatively or additionally, identified based on other geodemographic or socioeconomic characteristics including age, location, and/or number of members in a household, for example.

Spend analysis computing device 220 is further configured to use identified microsegments I, II, III and at least one of transaction data, credit-reporting data, and geodemographic data to match each of a plurality of cardholders A-I to an identified microsegment I, II, III. Spend analysis computing device 220 may be configured to perform such matching based on the geodemographic characteristics of each cardholder A-I. Microsegments I, II, III may also include any number of other (non-cardholder) members 504. Microsegments I, II, III may or may not have an equal or similar number of members 504. For example, in some embodiments, each microsegment I, II, III may have between 50 and 100 members 504, and in other embodiments, microsegments I, II, and III may have 10, 200, and 42 members 504, respectively.

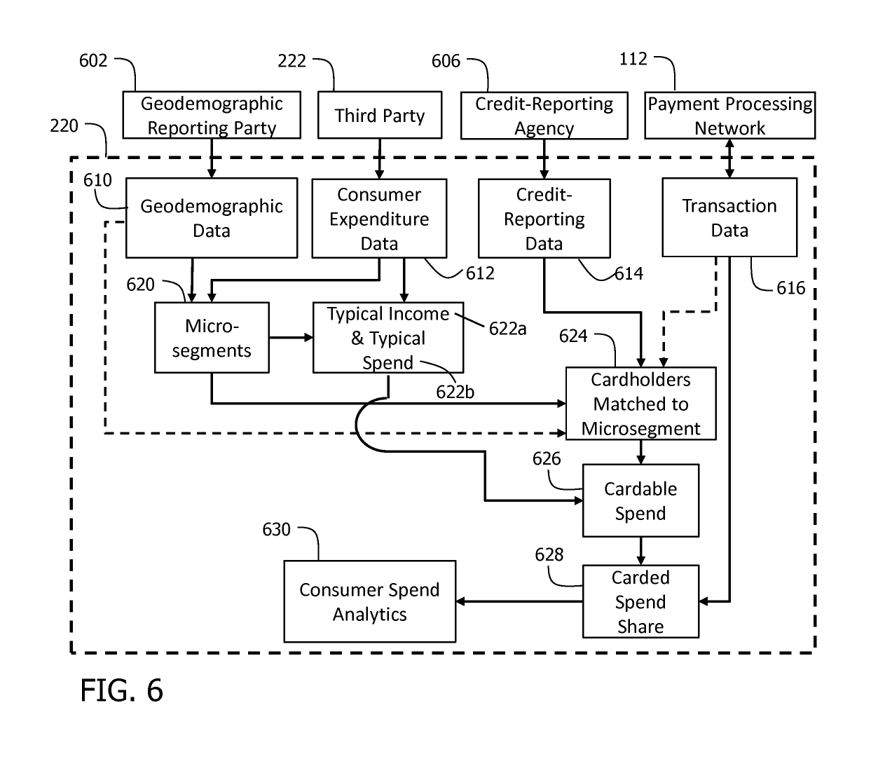

FIG. 6 shows a data-flow diagram illustrating the determination of consumer spend analytics by a spend analysis computing device 220, as shown in FIG. 2, in accordance with one example embodiment of the present disclosure. In the example embodiment, spend analysis computing device 220 receives geodemographic data 610 from a geodemographic reporting party 602, receives consumer expenditure data 612 (e.g., GCES data) from third party 222 (shown in FIG. 2), and retrieves transaction data 616 from payment processing network 112 (as shown in FIG. 1). In the example embodiment, spend analysis computing device 220 also receives credit-reporting data 614 from a credit-reporting agency 606. In other embodiments, spend analysis computing device 220 may not receive credit-reporting data 614. Geodemographic data 610, transaction data 616, and credit-reporting data 614 may be received and/or retrieved for a particular geographic area (e.g., a city, a state, a region, a nation, etc.) and/or for a population associated with or located in the geographic area.

Spend analysis computing device 220 identifies a plurality of microsegments 620, wherein each microsegment 620 represents a set of consumers having a typical income 622a and a typical spend 622b associated with the microsegment 620. Spend analysis computing device 220 may use geodemographic data 610 and/or consumer expenditure data 612 to identify microsegments 620 of the population. Generally, as described above with respect to FIG. 5, microsegments 620 may be identified based on geodemographic and/or socioeconomic characteristics of the population. Spend analysis computing device 220 may use consumer expenditure data 612 to determine the typical income 622a and typical spend 622b for any member of each identified microsegment 620.

In the example embodiment, spend analysis computing device 220 uses identified microsemgents 620 and credit-reporting data 614 to match each of a plurality of cardholders 624 to a particular identified microsegment 620. More specifically, spend analysis computing device 220 matches each cardholder for which spend analysis computing device 220 retrieved associated transaction data 616 to a microsegment 620 based on the credit-reporting data 614 for each cardholder. In some embodiments, spend analysis computing device 220 may, additionally or alternatively, match cardholders to a microsegment 620 using a different method, including, for example, using various matching algorithms and/or using transaction data 616, geodemographic data 610, and any other relevant data.

In the example embodiment, spend analysis computing device 220 uses the typical spend 622b and the typical income 622a for each microsegment 620 and matched cardholders 624 to calculate a cardable spend 626 for a cardholder 624 in each microsegment 620. Spend analysis computing device 220 determines average expenditures for a member of each microsegment 620 on noncardable expenditures (e.g., housing, taxes, healthcare) and subtracts the amount of noncardable expenditures from the typical income 622a for a member of each microsegment 620 to calculate the cardable spend 626 for a member of each microsegment 620. For example, for microsegment I, identified as described above, typical spend 622b determined using consumer expenditure data 612 may indicate an average expenditure on noncardable expenditures of the following:

TABLE 1

| NONCARDABLE | AVERAGE AMOUNT FOR |
|---|---|
| EXPENDITURE | MICROSEGMENT I |
| Mortgages interest and charges | $6,373 |
| Property taxes | $3,321 |
| Health Insurance | $2,649 |
| Medical Services | $1,230 |
| Personal Taxes | $5,784 |

From “Income before taxes: Average annual expenditures and characteristics, Consumer Expenditure Survey, 2011”, accessed at: http://www.bls.gov/cex/2011/Standard/income.pdf

The typical spend 622b for microsegment I may be calculated as $19,357. The typical income 622a may be calculated as $130,588 (based on, in this example, the average income before taxes for microsegment I). Therefore, the calculated cardable spend 626 for members of microsegment I may be calculated as $111,231 ($130,588−$19,357).

In the example embodiment, spend analysis computing device 220 uses calculated cardable spend 626 and transaction data 616 to calculate a carded spend share 628 that is associated with transactions initiated by a cardholder 624 using a payment device over payment processing network 112. For example, carded spend share 628 represents the fraction or percentage of a cardholder's 108 (shown in FIG. 1) cardable spend 626 spent using a credit card (payment device) over payment processing network 112. In one example, cardholder 108 associated with microsegment I spent $45,000 of her cardable spend 626 using the credit card (payment device) over payment processing network 112. Spend analysis computing device 220 calculates that carded spend share 626 for cardholder 108 as $45,000/$111,231=40%. In other words, cardholder 108 spent 40% of her cardable spend 626 using the payment device (e.g., credit card) over payment processing network 112. Spend analysis computing device 220 may assume that all or a portion of the remaining 60% of her cardable spend 626 may be spent using other payment methods (e.g., payment cards associated with other payment processing networks, cash, check, etc.).

Spend analysis computing device 220 uses calculated carded spend share 628, which is calculated for a plurality of cardholders 624, to determine various consumer spend analytics 630, as will be described in more detail below. Spend analysis computing device 220 may be configured to report the various determined consumer spend analytics 630 to any number of parties, including, but not limited to, payment processing network 112, merchant(s) 104, banks such as issuer bank 106 or merchant bank 110 (shown in FIG. 1), and other interested parties.

In some embodiments, spend analysis computing device 220 may be configured to determine an “average carded spend share” for a plurality of cardholders 624. Spend analysis computing device 220 may calculate a carded spend share 628 for each cardholder 624 of the plurality of matched cardholders 624, as described above. Spend analysis computing device 220 may then average the plurality of calculated carded spend shares 628. For example, there may be five cardholders 624 in a microsegment 620. If their respective carded spend shares 628 are 50%, 75%, 80%, 25%, and 45%, the average carded spend share for the plurality of cardholders 624 in that microsegment 620 is 55%.

In some embodiments, spend analysis computing device 220 may be configured to determine a “carded industry spend” that a cardholder 628 spent in a merchant industry. The carded industry spend refers to an amount spent by the cardholder 624 using the payment device over payment processing network 112 (i.e., a “carded” amount) at merchants in that merchant industry. Spend analysis computing device 220 may be configured to use transaction data 616 retrieved and/or received from payment processing network 112 to determine the carded industry spend for the cardholder 624.

Spend analysis computing device 220 may be further configured to determine a “cardholder industry spend” for the cardholder 624. The cardholder industry spend refers to a total amount (i.e., carded and non-carded) spent by the cardholder 624 in the merchant industry using any payment method (i.e., using the payment device over payment processing network 112 and any number of other payment methods including cash, check, and payment cards associated with other payment processing networks). Spend analysis computing device 220 may use the carded industry spend in the merchant industry and the carded spend share 628 for the cardholder 624 to determine the cardholder industry spend for the cardholder 624 in the merchant industry. For example, if the carded industry spend for the cardholder 624 is $80 in the gas industry for a particular period of time (e.g., a month), and if the calculated carded spend share 628 for the cardholder 624 using the payment device associated with payment processing network 112 is 80%, the determined cardholder industry spend is $100 for the gas industry. The $100 cardholder industry spend represents the $80 spend by the cardholder 624 using the payment device associated with the payment processing network 112 as well as $20 spent, for example, using cash, in the gas industry.

In some embodiments, spend analysis computing device 220 may be configured to determine an “average cardholder industry spend” for a plurality of cardholders 624 associated with a microsegment 620. The average cardholder industry spend represents an average amount spent by each of the plurality of cardholders 624 in a merchant industry using a payment device over payment processing network 112. Spend analysis computing device 220 may determine a cardholder industry spend for each of the plurality of cardholders 624, as described above. Spend analysis computing device 220 may then average the plurality of determined cardholder industry spends. For example, there may be five cardholders 624 in a microsegment 620, with respective cardholder industry spends of $250, $75, $150, $100, and $195 in the gas industry. The average cardholder industry spend for the gas industry for this microsegment 620, in this example, is $154.

Spend analysis computing device 220 may further be configured to determine an “average industry spend,” wherein the average industry spend represents an average amount spent by any consumer or member of the microsegment 620 (i.e., cardholders 624 and non-cardholders). Spend analysis computing device 220 may infer the average industry spend from the average cardholder industry spend. More specifically, spend analysis computing device 220 may take the average cardholder industry spend to be the average (cardholder 624 and non-cardholder) industry spend for any and all members of the microsegment 620, if it is assumed that an average cardholder member 624 of the microsegment 620 is an average (cardholder 624 or non-cardholder) member of the microsegment 620. Spend analysis computing device 220 may be configured to determine the average industry spend based on any other variables, including received geodemographic data 610, consumer expenditure data 612, credit-reporting data 614, or any other data.

In some embodiments, spend analysis computing device 220 may be configured to determine a “microsegment industry spend,” which represents a total amount spent by all members of a microsegment 620 in a merchant industry using any and all payment methods (e.g., payment device(s) associated with payment processing network 112, payment device(s) associated with other payment processing networks, cash, check, debit cards, etc.). Based on at least one of credit-reporting data 614, geodemographic data 610, and consumer expenditure data 612, spend analysis computing device 220 may be configured to determine a total number of members of a microsegment 620, including cardholders 624 and non-cardholders. Spend analysis computing device 220 may then use the average industry spend and the total number of members of the microsegment 620 to determine the microsegment industry spend. For example, if the average industry spend is $154 in the gas industry and spend analysis computing device 220 determines that there are 75 members of the microsegment 620, then spend analysis computing device 220 may determine that the microsegment industry spend in the gas industry is $11,550.

FIG. 7 is a flowchart of a process 700 for determining consumer spend analytics using system 200 shown in FIG. 2. In the example embodiment, process 700 is performed by spend analysis computing device 220 (shown in FIG. 2).

Spend analysis computing device 220 identifies 702 a plurality of microsegments of a population. Each microsegment includes a set of consumers having a typical income and a typical spend within a predetermined range associated with the microsegment. Identifying 702 may include determining the typical income and the typical spend based at least in part on consumer expenditure data. Consumer expenditure data may include GCES data and may be received from a third party (e.g., a government agency or any other third party).

Spend analysis computing device 220 retrieves 704 transaction data associated with a first cardholder from a payment processing network. Spend analysis computing device 220 further matches 706 the first cardholder to a first microsegment of the plurality of microsegments. Spend analysis computing device 220 may match 706 the first cardholder to a microsegment based on the retrieved transaction data, credit-reporting data received from a credit-reporting agency, matching logic, and/or any other data or technique.

Spend analysis computing device 220 calculates 708 a cardable spend for the first cardholder. Spend analysis computing device 202 may calculate 708 the cardable spend based on the typical income and the typical spend. Spend analysis computing device 220 further calculates 710 a carded spend share that the first cardholder spend using a first payment device over the payment processing network. Spend analysis computing device 202 may calculate 710 the carded spend share based at least on the cardable spend and the retrieved transaction data. Spend analysis computing device 220 may calculate 708, 710 a cardable spend and/or a carded spend share for a plurality of cardholders in the first microsegment and/or in another microsegments of the plurality of microsegments.

Spend analysis computing device 220 further determines 712 at least one consumer spend analytic based on the carded spend share. Spend analysis computing device 220 further reports 714 the carded spend share for the first cardholder and the at least one consumer spend analytic.

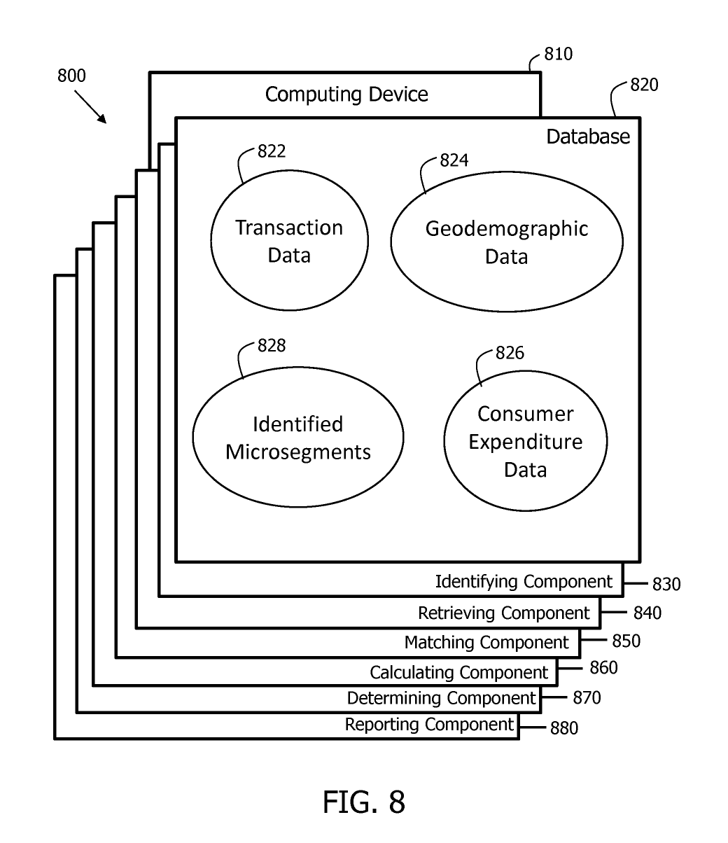

FIG. 8 is a diagram 800 of components of one or more example computing devices that may be used in system 200 shown in FIG. 2. In some embodiments, computing device 810 is similar to server system 212; computing device 810 may also be similar to spend analysis computer device 220 (both shown in FIG. 2). A database 820 may be coupled with several separate components within computing device 810, which perform specific tasks. In this embodiment, database 820 includes transaction data 822, geodemographic data 824, consumer expenditure data 826, and identified microsegments 828. In some embodiments, database 820 is similar to database 218 (shown in FIG. 2).

In the example embodiment, computing device 810 includes an identifying component 830. Identifying component 830 may be configured to identify a plurality of microsegments 828 of a population, wherein each microsegment 828 represents a set of consumers having a typical income and a typical spend associated with the microsegment 828.

Computing device 810 further includes a retrieving component 840, which may be configured to retrieve transaction data 822 associated with a first cardholder from a payment processing network (such as payment processing network 112, shown in FIG. 1). Retrieving component 840 may be further configured to retrieve and/or receive any other data, including geodemographic data 824, consumer expenditure data 826, credit-reporting data (not shown), and any other relevant data.

Computing device 810 further includes a matching component 850, which may be configured to match the first cardholder to a first microsegment 828 of the plurality of microsegments 828. In some embodiments, matching component may use transaction data 822, credit-reporting data, matching algorithm(s), and/or any other data to perform such matching.

Computing device 810 also includes a calculating component 860. Calculating component 860 may be configured to, for example, calculate a cardable spend and carded spend share for each cardholder associated with an identified microsegment 828. Computing device 810 also includes a determining component 870. At least one of calculating component 860 and determining component 870 may be configured to determine and/or calculate at least one consumer spend analytic, as described above, including, for example, average carded spend share, carded industry spend, cardholder industry spend, average cardholder industry spend, average industry spend, and microsegment industry spend. Determining component 870 may be configured to determine, for example, a typical spend and a typical income for member(s) of each identified microsegment 828 based on consumer expenditure data 826.

In the example embodiment, computer device 810 includes reporting component 880, which may be configured to report any output from any one of identifying component 830, retrieving component 840, matching component 850, calculating component 860, and determining component 870 to any interested party. For example, reporting component 880 may report output from calculating component 860 and determining component 870 to payment processing network 112. As another example, reporting component 880 may report output from at least one of calculating component 860 and determining component 870 to an issuing bank (e.g., issuer bank 106, shown in FIG. 1). Issuer bank 106 may use any data from reporting component 880 to implement various strategies to encourage various spending behaviors in cardholders using payment devices issued by issuer bank 106. For example, issuer bank 106 may implement a strategy to encourage cardholders with lower carded spend shares to use the payment device more frequently.

As used herein, the term “non-transitory computer-readable media” is intended to be representative of any tangible, computer-based device implemented in any method or technology for short-term and long-term storage of information, such as computer-readable instructions, data structures, program modules and sub-modules, or other data in any device. Therefore, the methods described herein may be encoded as executable instructions embodied in a tangible, non-transitory, computer-readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the embodiments, including the best mode, and also to enable any person skilled in the art to practice the disclosure, including making and using any devices or systems and performing any incorporated methods. The patentable scope of the embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer-implemented method for determining consumer spend analytics using a spend analysis computer device including a processor and a memory, said method comprising:
identifying a plurality of microsegments of a population, wherein each microsegment includes a set of consumers having a typical income and a typical spend within a predetermined range associated with the microsegment, and wherein the typical income and the typical spend are determined based at least in part on consumer expenditure data;
retrieving transaction data associated with a first cardholder from a payment processing network;
matching the first cardholder to a first microsegment of the plurality of microsegments;
calculating, based at least in part on the typical income and the typical spend of the set of consumers in the first microsegment, a cardable spend for the first cardholder;
calculating, based at least in part on the cardable spend and the retrieved transaction data, a carded spend share that the first cardholder spent using a first payment device over the payment processing network;
determining at least one consumer spend analytic based on the carded spend share; and
reporting the carded spend share for the first cardholder and the at least one consumer spend analytic.

2. The computer-implemented method of claim 1, further comprising receiving credit-reporting data for the population from a credit-reporting agency, wherein said matching the first cardholder to the first microsegment is based on the credit-reporting data.

3. The computer-implemented method of claim 1, wherein calculating a cardable spend comprises subtracting noncardable expenditures from the typical income of the first cardholder.

4. The computer-implemented method of claim 1 further comprising receiving the consumer expenditure data from a third party, wherein the consumer expenditure data includes Government Consumer Expenditure Survey (GCES) data.

5. The computer-implemented method of claim 1, method further comprising:
calculating a carded spend share for each cardholder of a plurality of cardholders in the first microsegment; and
determining an average carded spend share for the plurality of cardholders, wherein the at least one consumer analytic includes the average carded spend share.

6. The computer-implemented method of claim 1, further comprising:
determining a carded industry spend in a first merchant industry based on the transaction data, wherein the carded industry spend represents a carded amount spent by the first cardholder in the first merchant industry using the first payment device; and
determining a cardholder industry spend for the first cardholder in the first merchant industry based on the carded industry spend and the carded spend share, wherein the cardholder industry spend represents a total amount spent by the first cardholder in the first merchant industry using the first payment device and at least one other payment device, and wherein the at least one consumer analytic includes at least one of the carded industry spend and the cardholder industry spend.

7. The computer-implemented method of claim 6, further comprising:
determining a cardholder industry spend for a plurality of cardholders in the first microsegment;
determining an average cardholder industry spend for the plurality of cardholders; and
determining an average industry spend for any consumer in the first microsegment, based on the average cardholder industry spend.

8. The computer-implemented method of claim 7, further comprising:
receiving credit-reporting data for the population from a credit-reporting agency, wherein said matching a first cardholder to a first microsegment is based on the credit-reporting data; and
determining, based on the credit-reporting data and the average industry spend, a microsegment industry spend by the first microsegment in the first merchant industry, wherein the microsegment industry spend represents a total amount spend by all consumers in the first microsegment in the first merchant industry.

9. A spend analysis computing device used to determine consumer spend analytics, said spend analysis computing device comprising a processor communicatively coupled to a memory device, said processor programmed to:
identify a plurality of microsegments of a population, wherein each microsegment includes a set of consumers having a typical income and a typical spend within a predetermined range associated with the microsegment, and wherein the typical income and the typical spend are determined based at least in part on consumer expenditure data;
retrieve, from a payment processing network, transaction data associated with a first cardholder;
match the first cardholder to a first microsegment of the plurality of microsegments;
calculate, based at least in part on the typical income and the typical spend of the set of consumers in the first microsegment, a cardable spend for the first cardholder;
calculate, based at least in part on the cardable spend and the retrieved transaction data, a carded spend share that the first cardholder spent using a first payment device over the payment processing network;
determine at least one consumer spend analytic based on the carded spend share; and
report the carded spend share for the first cardholder and the at least one consumer spend analytic.

10. The spend analysis computing device of claim 9, wherein said processor is further programmed to:
receive credit-reporting data for the population from a credit-reporting agency; and
match the first cardholder to the first microsegment based at least in part on the credit-reporting data.

11. The spend analysis computing device of claim 9, wherein said processor is further programmed to subtract noncardable expenditures from the typical income of the first cardholder to calculate the cardable spend.

12. The spend analysis computing device of claim 9, wherein said processor is further programmed to receive the consumer expenditure data from a third party, wherein the consumer expenditure data includes Government Consumer Expenditure Survey (GCES) data.

13. The spend analysis computing device of claim 9, wherein said processor is further programmed to:
calculate a carded spend share for each cardholder of a plurality of cardholders in the first microsegment; and
determine an average carded spend share for the plurality of cardholders, wherein the at least one consumer analytic includes the average carded spend share.

14. The spend analysis computing device of claim 1, wherein said processor is further programmed to:
determine a carded industry spend in a first merchant industry based on the transaction data, wherein the carded industry spend represents a carded amount spent by the first cardholder in the first merchant industry using the first payment device; and
determine a cardholder industry spend for the first cardholder in the first merchant industry based on the carded industry spend and the carded spend share, wherein the cardholder industry spend represents a total amount spent by the first cardholder in the first merchant industry using the first payment device and at least one other payment device, and wherein the at least one consumer analytic includes at least one of the carded industry spend and the cardholder industry spend.

15. The spend analysis computing device of claim 14, wherein said processor is further programmed to:
determine a cardholder industry spend for a plurality of cardholders in the first microsegment;
determine an average cardholder industry spend for the plurality of cardholders; and
determine an average industry spend for any consumer in the first microsegment, based on the average cardholder industry spend, wherein the at least one consumer spend analytic further includes at least one of the average cardholder industry spend and the average industry spend.

16. The spend analysis computing device of claim 15, wherein said processor is further programmed to:
receive credit-reporting data for the population from a credit-reporting agency;
match the first cardholder to the first microsegment based at least in part on the credit-reporting data; and
determine, based on the credit-reporting data and the average industry spend, a microsegment industry spend by the first microsegment in the first merchant industry, wherein the microsegment industry spend represents a total amount spend by all consumers in the first microsegment in the first merchant industry, and wherein the at least one consumer spend analytic further includes the microsegment industry spend.

17. At least one non-transitory computer-readable storage media having computer-executable instructions embodied thereon, wherein when executed by a spend analysis computing device having at least one processor coupled to at least one memory device, the computer-executable instructions cause the processor to:
identify a plurality of microsegments of a population, wherein each microsegment includes a set of consumers having a typical income and a typical spend within a predetermined range associated with the microsegment, and wherein the typical income and the typical spend are determined based at least in part on consumer expenditure data;
retrieve, from a payment processing network, transaction data associated with a first cardholder;
match the first cardholder to a first microsegment of the plurality of microsegments;
calculate, based at least in part on the typical income and the typical spend of the set of consumers in the first microsegment, a cardable spend for the first cardholder;
calculate, based at least in part on the cardable spend and the retrieved transaction data, a carded spend share that the first cardholder spent using a first payment device over the payment processing network;
determine at least one consumer spend analytic based on the carded spend share; and
report the carded spend share for the first cardholder and the at least one consumer spend analytic.

18. The computer-readable storage medium of claim 17, wherein
the computer-executable instructions further cause the processor to:
receive credit-reporting data for the population from a credit-reporting agency; and
match the first cardholder to the first microsegment based at least in part on the credit-reporting data.

19. The computer-readable storage medium of claim 17, wherein
the computer-executable instructions further cause the processor to subtract noncardable expenditures from the typical income of the first cardholder to calculate the cardable spend.

20. The computer-readable storage medium of claim 17, wherein
the computer-executable instructions further cause the processor to receive the consumer expenditure data from a third party, wherein the consumer expenditure data includes Government Consumer Expenditure Survey (GCES) data.

21. The computer-readable storage medium of claim 17, wherein the computer-executable instructions further cause the processor to:
calculate a carded spend share for each cardholder of a plurality of cardholders in the first microsegment; and
determine an average carded spend share for the plurality of cardholders, wherein the at least one consumer analytic includes the average carded spend share.

22. The computer-readable storage medium of claim 17, wherein the computer-executable instructions further cause the processor to:
determine a carded industry spend in a first merchant industry based on the transaction data, wherein the carded industry spend represents a carded amount spent by the first cardholder in the first merchant industry using the first payment device; and
determine a cardholder industry spend for the first cardholder in the first merchant industry based on the carded industry spend and the carded spend share, wherein the cardholder industry spend represents a total amount spent by the first cardholder in the first merchant industry using the first payment device and at least one other payment device, and wherein the at least one consumer analytic includes at least one of the carded industry spend and the cardholder industry spend.

23. The computer-readable storage medium of claim 22, wherein the computer-executable instructions further cause the processor to:
determine a cardholder industry spend for a plurality of cardholders in the first microsegment;
determine an average cardholder industry spend for the plurality of cardholders; and
determine an average industry spend for any consumer in the first microsegment, based on the average cardholder industry spend, wherein the at least one consumer spend analytic further includes at least one of the average cardholder industry spend and the average industry spend.

24. The computer-readable storage medium of claim 23, wherein the computer-executable instructions further cause the processor to:
receive credit-reporting data for the population from a credit-reporting agency;
match the first cardholder to the first microsegment based at least in part on the credit-reporting data; and
determine, based on the credit-reporting data and the average industry spend, a microsegment industry spend by the first microsegment in the first merchant industry, wherein the microsegment industry spend represents a total amount spend by all consumers in the first microsegment in the first merchant industry, and wherein the at least one consumer spend analytic further includes the microsegment industry spend.
